(19) United States
(12) Patent Application Publication
(10) Pub. No.: US 2010/0155430 A1
(43) Pub. Date: Jun. 24, 2010

(54) Curved Dip Tube for Sprayer Heads

(75) Inventor: Darrell J. Schwandt, Centennial, CO (US)

Correspondence Address: Darrell Schwandt, 7422 S. Genoa Ct, Centennial, CO, 80016, US

(73) Assignee: Darrell J. Schwandt, Centennial, CO (US)

(21) Appl. No.: 12/372,742

(22) Filed: Feb. 18, 2009

Related U.S. Application Data
(60) Provisional application No. 61/138,801, filed on Dec. 18, 2008.

(51) Int. Cl. B67D 5/12

(52) U.S. Cl. 222/383.3

(57) ABSTRACT

A curved dip tube for sprayer heads that solves the problem of spraying air as a container's contents are dispensed and reduced to a level that allows the tip of a straight dip tube to become disengaged with the liquid as the container is tilted downward. As the user of a sprayer head tilts or tips it from a vertical to a horizontal position to spray the intended target the liquid level pools at the lowest point in the container. It then becomes advantageous for the tip of the curved dip tube to be positioned on the lowest point where the bottom meets the wall. This is accomplished by lengthening the dip tube and then curving it to direct the tip toward the side. Once installed onto a sprayer head and inserted into a container the curved dip tube extends toward the bottom of the container, curves and follows the contour of the bottom of the container, pointing in the same direction as the sprayer head output nozzle. The liquid contents of the container can now be fully consumed without spraying air during operation as the consumer uses the product in its entirety.

### CROSS-REFERENCE TO RELATED APPLICATIONS

This application claims the benefits of provisional patent application serial number 61138801 filed Jan. 5, 2009 by the present inventor.

### FEDERALLY SPONSORED RESEARCH

Not applicable

### SEQUENCE LISTING OR PROGRAM

Not applicable

### BACKGROUND

1. Field

This application relates to sprayer heads, specifically to the design of the dip tube used to pick up the contents of spray bottles.

2. Prior Art

For the purpose of clarity in this application the term “dry fire” is defined as: When a spray bottle still contains liquid but the dip tube extending from the sprayer head becomes disengaged with the liquid and the sprayer head pumps air instead of liquid.

The prior art can be broken up into 4 groups. Common sprayer heads, designs using flexible dip tubes, designs deflecting the dip tube to a corner of the bottle and designs in which the sprayer head is redesigned to allow inverted spraying.

Currently common sprayer heads use straight dip tubes or slightly-extended straight dip tubes. U.S. Pat. No. 5,762,236 indicates the straight dip tube is the most commonly used means to reach the liquid at the bottom of a spray bottle. When the bottle is full of liquid the straight dip tube works just fine. But when the bottle begins to empty, if the bottle is tipped downward or upward, the user experiences dry fire and it is difficult to use all the contents of spray bottles.

The slightly extended dip tube is a recent addition to spray bottles. Like U.S. Pat. No. 3,301,438 some manufacturers have beveled the bottom of spray bottles and extended the dip tube. When the dip tube is inserted, the bevel on the bottom of the bottle pushes the tip of the dip tube to one side or the other. Unfortunately, for many end users the dip tube is pointing in the wrong direction. Since many spray bottles are colored or opaque, instead of clear, the end user has no idea the dip tube is on the wrong side and it exasperates the problem of dry fire and the inability to use all the contents.

Prior art has seen the use of flexible dip tubes in place of semi ridged dip tubes such as US Pat. No. 2008/0047982 and U.S. Pat. No. 5,195,664. Whenever flexible dip tubes are used it either carries a weight on the end or a bobber. The flexible dip tube with a weight or bobber is designed to keep the tip of the dip tube in contact with the contents of a spray bottle in an effort to stop dry fire. But many spray bottles are now designed with a bevel on the bottom and the weight or bobber can easily be caught on the wrong side of the bevel. Whether the bottle has a bevel bottom or a flat bottom neither the weight nor bobber can ensure the tip of the flexible dip tube would stay in contact with the lower corner of the bottle to help the user avoid dry fire.

There are other limitations of flexible dip tubes integrated onto sprayer heads. In order for a material to be flexible enough it must contain rubber which has a different chemical compatibilities. Nylon and Polyethylene are the common semi ridged material used for dip tubes and they have a wide range of chemical compatibility. Also, the rubber material combined with the weight or bobber, have a higher cost then nylon or polyethylene dip tubes used in spray bottles.

Prior art also includes changes to the bottle design. Like U.S. Pat. No. 6,834,815 and U.S. Pat. No. 6,742,677 some designs exist in which the spray bottle has a deflection piece built in to the inside of the bottle to deflect the dip tube into the corner of the bottle. Although it allows for the more common ridged or semi-ridged dip tube and helps eliminate dry fire; the change is to the bottle or mechanism and has increased the price of manufacturing the bottle.

Finally prior art has brought changes to sprayer head design such as U.S. Pat. No. 5,462,209. There are design changes to the sprayer heads that allows a, sprayer head to be sprayed upright, at 90 degrees and inverted. These designs are much more complicated than standard sprayer heads as they incorporates multiple

check valves, multiple fluid entry points and a larger housing. Although this design does help eliminate dry fires and allows the user to spray inverted, these complex designs have a higher cost to manufacture and as a result tend to be offered as specialty sprayer heads.

Curved dip tube for sprayer heads has many features to address the shortcomings of the groups presented as prior art. The curved dip tube can be made from the exact same materials already used by the industry. The common materials used now for dip tubes has a semi ridged quality which ensures the tip of the curved tube will stay positioned even if the bottle is shaken or dropped. In addition it can be made in a variety of ways to accommodate the height, width and dimensions of all spray bottles. That means spray bottles and sprayer heads will not have to be redesigned. In addition the curved dip tube can be used on trigger sprayers, pump sprayers, aerosol cans, electric pumps or any devise in which the contents can be picked up by a tube.

### SUMMARY

The curved dip tube for sprayer heads will assist in dispensing the contents of a spray bottle in a continuous flow without dry fire and utilizing the entire contents of the bottle while the bottle is tilted downward between 0 and 90 degrees.

### DRAWINGS

### Figures

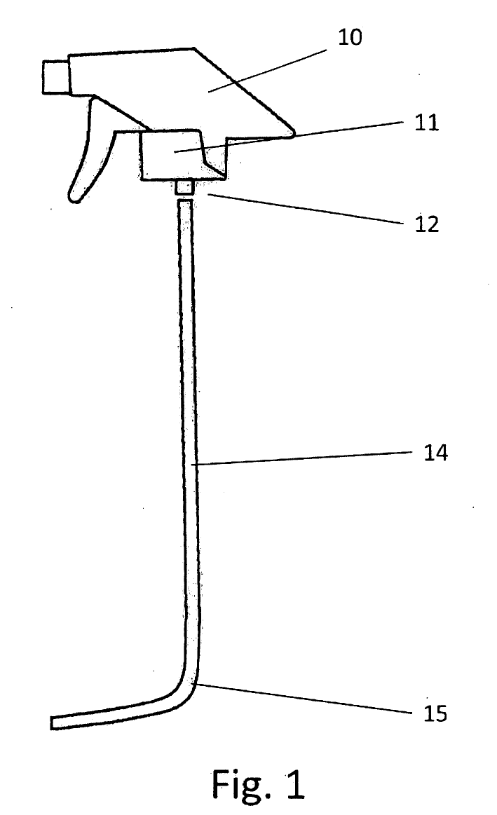

FIG. 1 shows a curved dip tube aligned with a standard sprayer head.

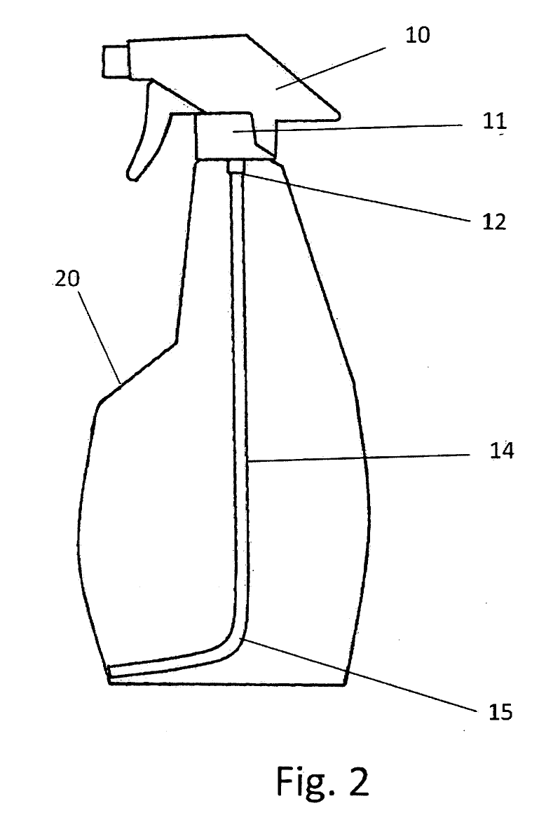

FIG. 2 shows a curved dip tube aligned with a standard sprayer head inserted into a flat bottomed oval spray bottle.

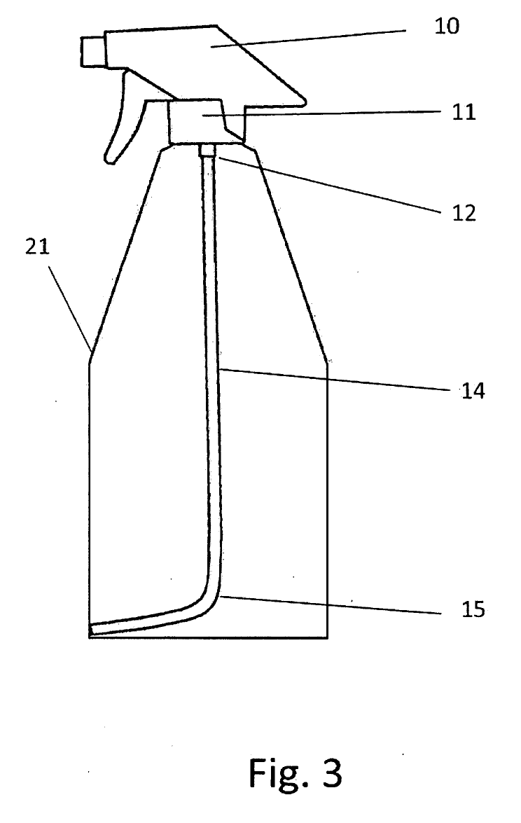

FIG. 3 shows a curved dip tube aligned with a standard sprayer head inserted into a flat bottomed circular spray bottle.

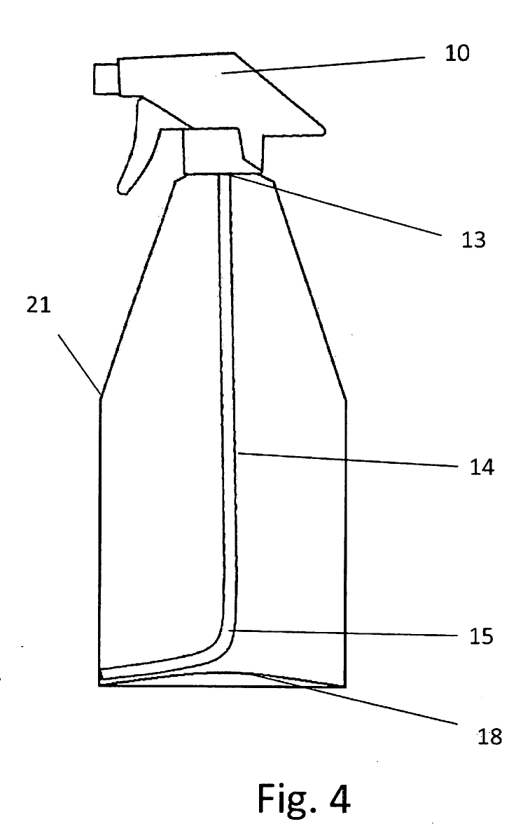

FIG. 4 shows an integral curved dip tube aligned with a standard sprayer head inserted into a bevel bottomed circular spray bottle.

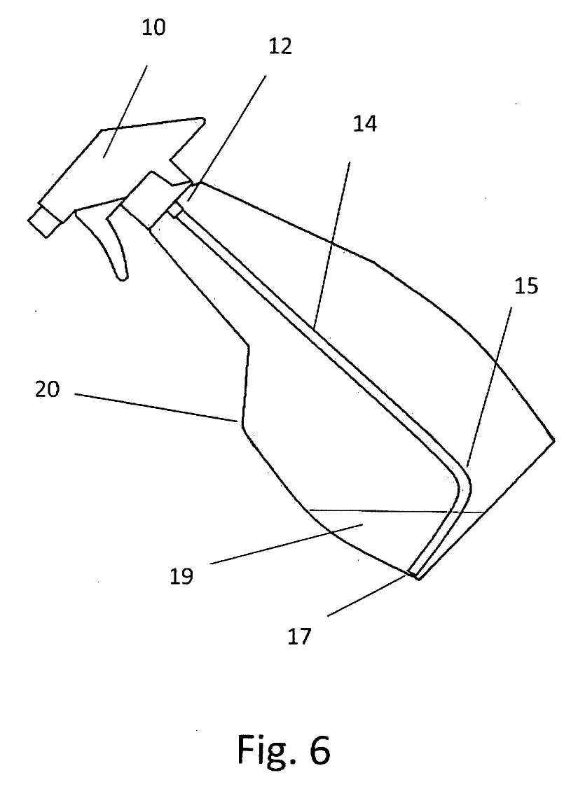

FIG. 6 shows a curved dip tube aligned with a standard sprayer head inserted into an oval spray bottle tipped downward to show the contents pooling in the lower corner.

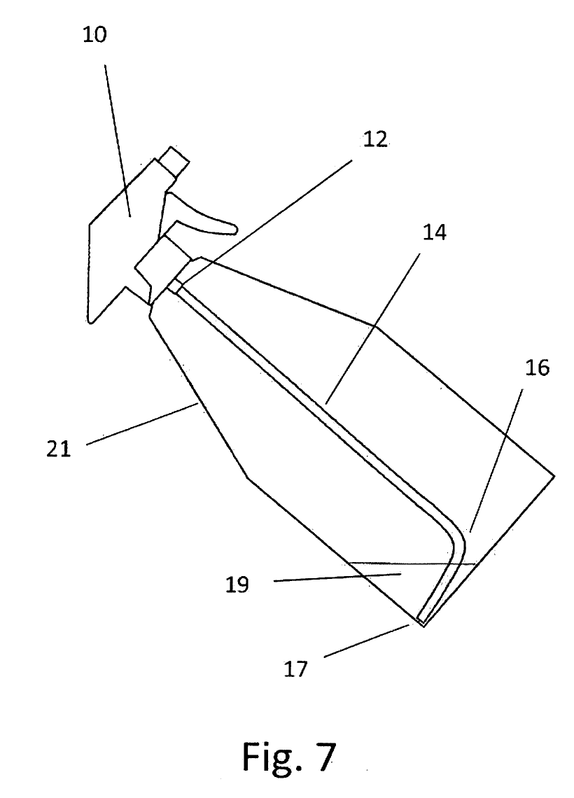

FIG. 7 shows a curved dip tube reverse aligned with a standard sprayer head inserted into a circular spray bottle tipped upward to show the contents pooling in the lower corner.

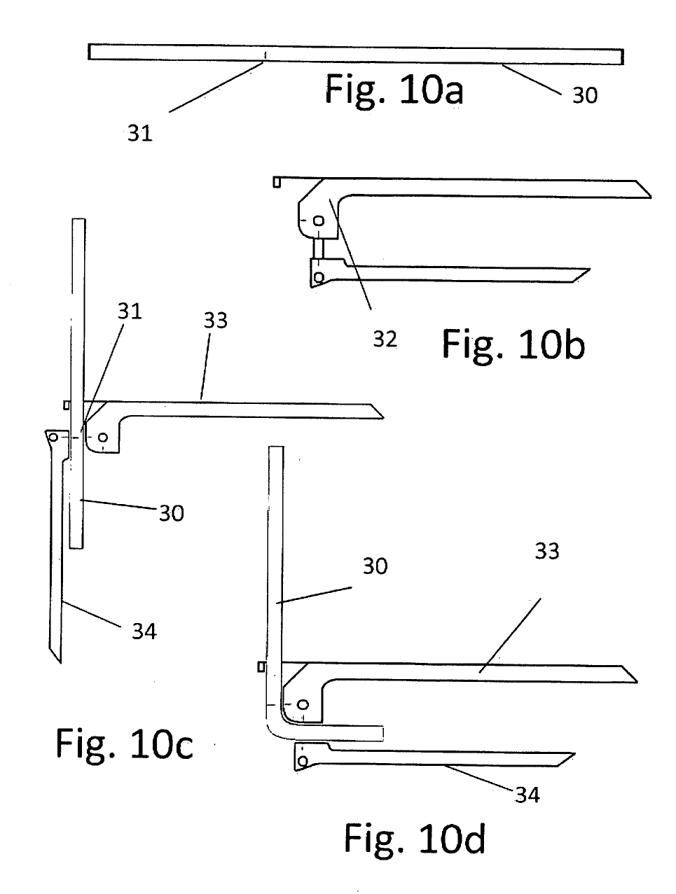

FIG. 10a-d shows how to bend ridged tubing to the correct dimensions.

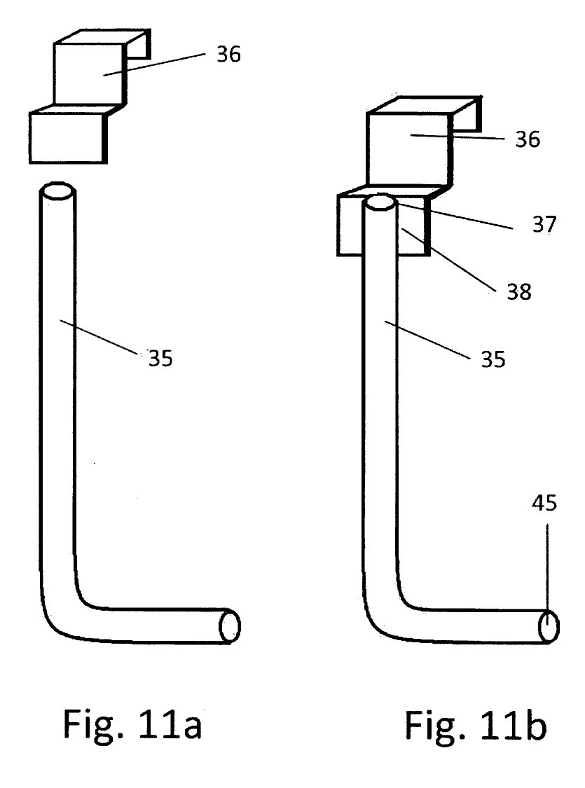

FIG. 11a-b shows how attach the guide bracket to the bent ridged tubing.

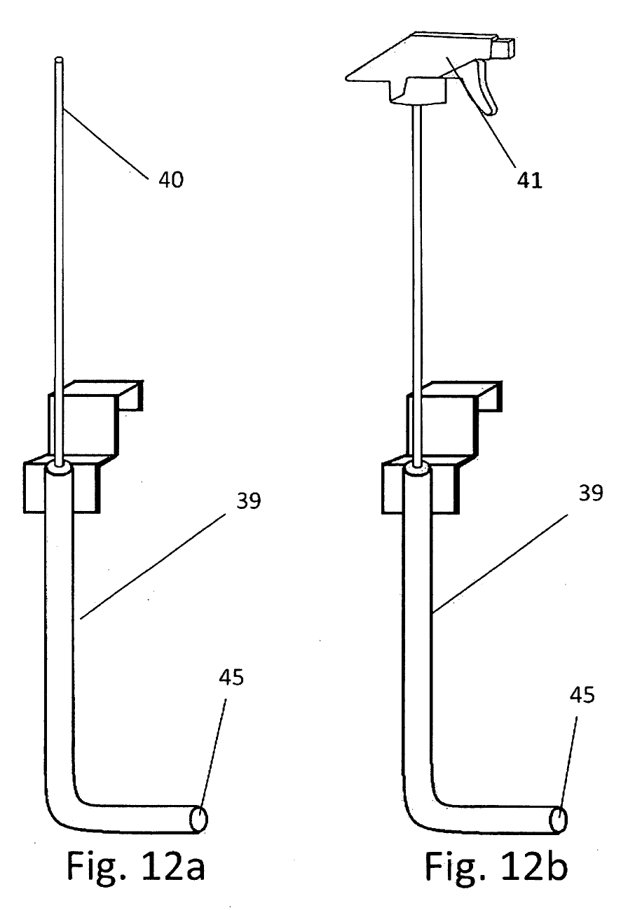

FIG. 12a-b shows a plastic type tube and a sprayer head with an integral dip tube preparing to be inserted into the form.

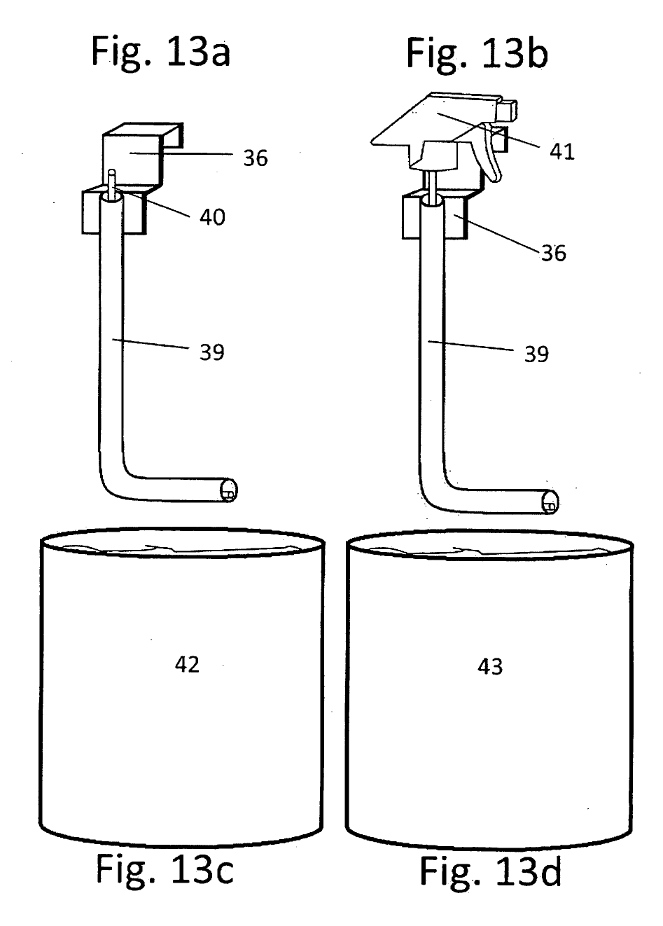

FIG. 13a-d shows a straight dip tube and a sprayer head with an integral dip tube inside the forms preparing to be inserted into hot and cold baths.

DRAWINGS - REFERENCE NUMERALS

| | | | |
|---|---|---|---|
| 10 | Sprayer head | 11 | Sealing cap. |
| 12 | Dip tube connection point. | 13 | Integrated dip tube. |
| 14 | Full length curved dip tube. | 15 | Aligned curved section. |
| 16 | Reverse aligned curved section | 17 | The tip of the curved dip tube. |
| 18 | Bevel bottom of spray bottle. | 19 | Contents of spray bottle. |
| 20 | Oval shaped bottle. | 21 | Circular bottle. |
| 30 | Ridged tubing. | 31 | Mark for the bend line. |
| 32 | Tube bender. | 33 | Long arm of tube bender. |
| 34 | Short arm of tube bender. | 35 | Bent ridged tube. |
| 36 | Guide bracket. | | |
| 37 | Point where the tip of bent | | |
| | ridged tube meets the | | |
| | guide bracket. | | |
| 38 | The weld point. | | |
| 39 | The form. | | |
| 40 | Plastic type tube. | | |
| 41 | Sprayer head with the | | |
| | integral dip tube. | | |
| 42 | Hot water bath. | | |
| 43 | Cold water bath. | | |
| 45 | Bottom tip of the form. | | |

### DETAILED DESCRIPTION

### FIG. 1, FIG. 2 and FIG. 3—First Embodiment

One embodiment of the curved dip tube is illustrated in FIG. 1, FIG. 2 and FIG. 3. FIG. 1 shows the curved dip tube 14 and a sprayer head 10. The sprayer head 10 is a 1.0 ml sprayer head—available through Unisan Products of Los Angeles, Calif. The relevant variations on sprayer heads related to this application are sealing cap size and dip tube connection size or integral dip tube. The sealing cap size 11 preferred by most sprayer head manufacturers is 28-400, although there are other sizes used in industry such as 28-410 and 28-415. The sealing cap size 11 need only fit the bottle 20 (FIG. 2) 21 (FIG. 3) to be used. The dip tube connections 12 size can vary. The curved dip tube 14 outer diameter need only match the inner diameter of the dip tube connection 12. Once matched the curved dip tube 14 can be inserted into the dip tube connection 12 beneath the sealing cap 11. The preferred material for the curved dip tube 14 is nylon or polyethylene as they are inexpensive and possess good chemical compatibility characteristics. Both nylon and polyethylene tubing are available through Hudson Extrusion of Hudson Ohio. Although nylon and polyethylene are the most common materials used for dip tubes many other materials can be used including but not limited to polyvinyl chlorine, polypropylene, polystyrene, Nitrile, Ethylene propylene, Teflon, Polyurethane and Viton. The preferred radius of the curved section 15 of this embodiment is a 1.25 inch radius. Although the curve radius can vary, it need only be smaller than the diameter of a circular bottle 21 (FIG. 3) or the long diameter of an oval bottle 20 (FIG. 2). The bottles 20 (FIG. 2) 21 (FIG. 3) are available through Indiana Bottle Company in Scottsburg, Ind. Bottles 20 (FIG. 2) 21 (FIG. 3) are available in many different sizes, shapes and materials. The material need only be chemically compatible with the contents and the connection size should match the sprayer head 10 sealing cap 11. The length and width of the curved dip tube 14 can be altered to fit the variations in the size and shape of the bottles 20 (FIG. 2) 21 (FIG. 3).

### OPERATION

### FIG. 6 and FIG. 7

The elimination of dry fire and utilization of all the contents while spraying down is illustrated in FIG. 6. When spraying down the elimination of dry fire and utilization of all the contents 19 of the spray bottle 20 is obtained when the curved section 15 is aligned with the sprayer head 10. This is achieved when the curved dip tube 14 is pushed into the dip tube connection 12 on the sprayer head 10 such that the tip 17 is pointing in the same direction as the sprayer head 10. The tip 17 of the curved dip tube 14 is now positioned in the lowest position of the spray bottle 20. When the spray bottle is tipped downward anywhere between 0 and 90 degrees the contents 19 pools at the Tip 17 of the curved dip tube 14 allowing the sprayer head 10 to continue to spray the contents 19 without dry fire until all the contents 19 are used.

The elimination of dry fire and utilization of all the contents while spraying upward is illustrated in FIG. 7. When spraying up the elimination of dry fire and utilization of all the contents 19 of the spray bottle 20 is obtained when the curved section 16 is reverse aligned with the sprayer head 10. This is achieved when the curved dip tube 14 is pushed into the dip tube connection 12 on the sprayer head 10 such that the tip 17 is pointing in the opposite direction as the sprayer head 10. The tip 17 of the curved dip tube 14 is now positioned in the lowest position of the spray bottle 20. When the spray bottle is tipped upward anywhere between 0 and 90 degrees the contents 19 pools at the Tip 17 of the curved dip tube 14 allowing the sprayer head 10 to continue to spray the contents 19 without dry fire until all the contents 19 are used.

### FIG. 4

### Additional Embodiments

Other embodiments are illustrated in FIG. 4. This figure illustrates an integral curved dip tube 14 as an assembly component of the sprayer head 10 and a circular bottle 21 with a beveled bottom 18. When the curved dip tube 14 is manufactured it is done with the sprayer head 10 attached so the bottle 21 dimensions and bevel 18 configuration must be specified to achieve the proper length, width and curve diameter of the curved dip tube 14.

### FIG. 10-14 Technique for Making the Curved Dip Tube 14 (FIG. 1)

The technique used for making the curved dip tube 14 (FIG. 1), out of plastic type tubing, begins with making a form 39 (FIG. 12) for the curved shape. Instructions for how to make the form 39 (FIG. 12) is illustrated in FIG. 10 and FIG. 11. The preferred way is to use 0.375 inch stainless steel tubing 30 (FIG. 10a) cut to 11.25 inches, although a variety of materials can be used. Place a mark 31 on the tubing 30 (FIG. 10a) 8 inches from the end. Use a tube bender 32 (FIG. 10b) with a 1.25 inch bend radius. Open the short arm 34 (FIG. 10c) by pushing the end away from long arm 33 and insert the tubing 30 so the mark 31 lines up with the start position on the long arm 33 and the short arm 34. Pull the end of the short arm 34 (FIG. 10d) toward the end of the long arm 33 in a smooth motion. Stop the motion when the mark on the short arm 34 lines up with the end mark on the long arm 33. The tubing 30 is now bent to 90 degrees. Release the short arm 34 and remove the tubing 30. The stainless steel tubing and tube bender can be obtained at Home Depot in Centennial Colo.

The bracket 36 (FIG. 11a) is 5 inches long, 2 inches wide, ⅛^{th} inch thick stainless steel flat bar stock. Four 90 degree bends are added. The first bend is started 1 inch from the end and each subsequent bend is 1 inch further from the previous bend to give the desired shape. The bracket 36 (FIG. 11b) is positioned such that tip 37 of the bent tubing 35 is flush with top of the first bend 37 on the bracket 36 and the fiat edge of the bracket to be welded should be pointing in the same direction as the tip 45 of the bent tubing 35. Weld the bent tube 35 to the bracket 36 at the contact point 38 to create the form 39 (FIG. 12a).

Instructions on how to make the curved dip tube is illustrated in FIG. 12 and FIG. 13. The hot water bath 42 (FIG. 13c) should be filled to within an inch of the top with 212 degree Fahrenheit water. The cold water bath 43 (FIG. 13d) should be filled to within an inch of the top with 60 degree Fahrenheit water. The plastic type tubing in this example is three sixteenths inch nylon tubing although a variety of materials and sizes can be used. Cut the tubing 40 (FIG. 12a) to a length of 11.5 inches and insert into the top of the form 39 (FIG. 12a) until the tip of the tubing 40 is flush with the bottom end 45 of the form 39. With the tubing 40 (FIG. 13a) inserted into the form 39 (FIG. 13a) drop the form 39 into the hot water bath 42 (FIG. 13c) using the guide bracket 36 to hang the form 39 on the edge of the hot water bath 42. After 30 seconds remove the form 39 from the hot water bath 42 and insert into the cold water bath 43 (FIG. 13d) using the guide bracket 36 to hang the form 39 on the edge of the cold water bath 43. Wait 30 seconds and remove the form 39 from the cold water bath 43. When you remove the tubing 40 from the form 39 you now have a curved dip tube 14 (FIG. 1) with a vertical long length of 9.5 inches and a horizontal short length of 3 inches.

Instructions on how to make a sprayer head with an integral curved dip tube is illustrated in FIG. 12 and FIG. 13. The hot water bath 42 (FIG. 13c) should be filled to within an inch of the top with 212 degree Fahrenheit water. The cold water bath 43 (FIG. 13d) should be filled to within an inch of the top with 60 degree Fahrenheit water. The plastic type tubing in this example is integrated into the sprayer head as a part of the assembly. In this example the integral dip tube is three sixteenths inch nylon tubing and cut to 11.5 inches, although a variety of materials and sizes can be used. Insert the sprayer head with the integral dip tube 41 (FIG. 12b) into the top of the form 39 (FIG. 12b) until the tip of the integral dip tube 41 is flush with the bottom end 45 of the form 39 and the sprayer head 41 is pointing in the same direction as the tip 45. With the sprayer head with the integral dip tube 41 (FIG. 13b) inserted into the form 39 (FIG. 13b) drop the form 39 into the hot water bath 42 (FIG. 13c) using the guide bracket 36 to hang the form 39 on the edge of the hot water bath 42. After 30 seconds remove the form 39 from the hot water bath 42 and insert into the cold water bath 43 (FIG. 13d) using the guide bracket 36 to hang the form 39 on the edge of the cold water bath 43. Wait 30 seconds and remove the form 39 from the cold water bath 43. When you remove the sprayer head with the integral dip tube 41 from the form 39 you now have a sprayer head with the integral curved dip tube 14 (FIG. 1) with a vertical long length of 9.5 inches and a horizontal short length of 3 inches.

### ADVANTAGES

From the description above, a number of advantages of embodiments of the curved dip tube for sprayer heads become evident.

The materials used are the same as the materials already in use by the industry. There are no new chemical compatibility issues. Due to the semi ridged nature of the standard materials use for dip tubes the tip of the curved dip tube will stay in the optimal position even if the bottle is shaken or dropped. The effectiveness can be obtained for only a fraction of a penny making it a cost effective alternative. The curved dip tube for sprayer heads can be made separate of the sprayer head or formed with the dip tube integrated into the sprayer head. The improvement requires no new product changes by the spray bottle and sprayer head industries and it can be used in a variety of applications.

### CONCLUSION, RAMIFICATIONS AND SCOPE

Accordingly, the reader will see the curved dip tube for sprayer heads and its embodiments offer the users of sprayer bottles a vast improvement in effectiveness toward eliminating dry fire and assist in utilizing all the contents of a spray bottle. In addition, the curved dip tube for sprayer heads has these additional advantages:
a) The tubing can be made of a variety of materials including the common materials used by spray bottle and sprayer head manufacturers. These manufacturers need only increase the length of the tubing they already buy in large quantities. For common use materials the increase in material costs would add a fraction of a penny to the cost of the product.
b) Since all the same materials are being used there is no chemical compatibility issues that don't already exist with the materials used by manufactures today.
c) The common materials used for dip tubes have a semi ridged quality. This ensures the tip of the curved dip tube will stay in the optimal position even if the bottle is shaken or dropped.
d) The curved dip tube for sprayer heads can be made in variety of ways to accommodate all bottles regardless of height, width and shape.
e) The curved dip tube can be manufactured separate of the sprayer heads or formed with the dip tube integrated into the sprayer head.
f) Spray bottle and sprayer head manufacturers will not have to redesign their products to accommodate the curved dip tube for sprayer heads.
g) The curved dip tube can be used on trigger sprayers, pump sprayers, aerosol cans, electric pumps or any devise in which the contents can be picked up by a dip tube.

Although the description above contains many specifications, these should not be construed as limiting the scope of the embodiments but as merely providing illustrations of some of the presently preferred embodiments. For example the material for the form and guide bracket can be stainless steel, copper, brass, aluminum or steel. Or, the heat source for the process of curving the tubing can be air, water or steam and the form can be inserted into the hot source and cold source for shorter or longer periods of time. Also, the curve radius of the tubing can vary depending on the forms used to manufacture the curved dip tube.

Thus the scope of the embodiments should be determined by the appended claims and their legal equivalents rather than by the examples given.

1) A tube for fluid pickup, adapted for use with a container for housing a liquid and coupled with a pump capable of discharging liquid from the interior volume of the container, wherein the tube for fluid pick up comprises:
a. A plastic tube;
b. Said tube has a straight portion extending downward from said pump a predetermined distance, a curved portion and a straight portion extending a predetermined distance to the wall of said container.

2) The tube according to claim 1, wherein said pump has a connecting means with the first open end of said tube.

3) The tube according to claim 1, wherein said tube with a second open end positioned pointing at said wall and in close proximity to the bottom of said container.
